(19) United States
(12) Patent Application Publication
(10) Pub. No.: US 2015/0325091 A1
(43) Pub. Date: Nov. 12, 2015

(54) IDENTIFICATION ACQUISITION DEVICE FOR REDUCING THE LIKELIHOOD OF INCIDENCE OF A LAPSE IN PROPER DISCHARGE OF A SECURITY PROCEDURE

(71) Applicant: SECURITY SOLUTIONS & MANAGEMENT LLC, Charlotte, NC (US)

(72) Inventors: Jeffery Shane Hamilton, Fort Mill, SC (US); Michael David Gardner, Weddington, NC (US)

(21) Appl. No.: 14/647,768

(22) PCT Filed: Nov. 26, 2013
(86) PCT No.: PCT/US2013/072087

§ 371 Date: May 27, 2015

Related U.S. Application Data
(60) Provisional application No. 61/730,324, filed on Nov. 27, 2012.

(51) Int. Cl. G08B 13/22; G07C 9/00

(52) U.S. Cl. CPC G08B 13/22; G07C 9/00079; G07C 9/00111

(57) ABSTRACT

Apparatus and methods reduce a likelihood of incidence of a lapse in proper discharge of a routine, repetitive security procedure performed by a security guard (14) monitoring an access-controlled location (28). A hand-mounted identification acquisition device (12) worn by the security guard obtains identification information (34) from a person seeking access (32). A transmitter (44) is operatively associated with the device and configured to transmit the identification information to an access-control system (16). A transmission from the access-control system of authorization information indicates whether the identification information corresponds to stored authorization data associated with one of the authorized persons. A display screen (68) presents visual authorization information (70) so that the security guard can compare the physical characteristics of the person seeking access to physical characteristics of the one of the authorized persons shown in an image (72) appearing on the display screen.

### RELATED APPLICATION

This application claims priority benefit of U.S. Provisional Patent Application No. 61/730,324, filed Nov. 27, 2012, which is hereby incorporated by reference.

### COPYRIGHT NOTICE

©2013 Security Solutions & Management LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure generally relates to verification of identification information presented by an access seeker to a security guard for obtaining access to a secured area, and, more particularly, to a portable identification-verification system carried by a security guard.

### BACKGROUND INFORMATION

Attempts to restrict access to access-controlled locations have included so-called self-service systems. These systems include an access controller (e.g., a door controller) having an interface that a person seeking access uses to present identification information encoded in the form of biometric characteristics, proximity card signals, magnetic stripe, optical code symbols, radio frequency identification (RFID), or other forms. The identification information obtained from the access seeker is checked against authorization data to determine whether the access seeker is authorized to access the access-controlled location.

Self-service systems are typically deployed in low-level security areas because such systems lack mechanisms for determining whether an access seeker has misappropriated identification information of an authorized person. For example, a non-authorized access seeker presenting identification information associated with an authorized person would simply be treated by the access controller as having the authorization of the authorized person associated with the misappropriated identification information.

Higher-level security areas, such as military bases and other secure facilities, maintain security guards stationed near the perimeter of an access-controlled location to regulate and deny access to access seekers presenting identification information that is either non-authorized (e.g., invalid, expired, not yet authorized, or affirmatively unauthorized) or misappropriated (but otherwise authorized). Determining whether identification information is non-authorized entails reading the identification information presented to the security guard and checking it against stored authorization data. But determining whether identification information is misappropriated entails determining that the access seeker is, in fact, the person who is authorized to access the location under the identification information. For example, a security guard may inspect the authenticity of an identification card, check his or her records or another access-control system to determine whether the identification card information has appropriate access permissions, and perhaps compare an image of the authorized person shown on the card to the access seeker's face. Failure to perform any one of these steps could jeopardize the security of the access-controlled location.

### SUMMARY OF THE DISCLOSURE

An information acquisition device allows security guards to communicate with an access-control system, obtain and approve at a remote location the authorization status of an access seeker, and invoke alarms or revise stored authorization data. Additional aspects and advantages will be apparent from the following detailed description of embodiments, which proceeds with reference to the accompanying drawings.

### BRIEF DESCRIPTION OF THE DRAWINGS

FIG. 1 is a hybrid block and pictorial diagram of an identification-verification system including an access-control system and a portable information acquisition device worn by a security guard to obtain identification information provided by a person seeking access to an access-controlled location secured by a gatehouse access controller.

FIG. 2 is an enlarged fragmentary view of the hand and forearm of the security guard to whom is attached the identification acquisition device of FIG. 1, showing a hand-mounted data reader and a wrist-mounted user interface display screen mounted respectively on a non-dominant hand and wrist of the security guard, and showing, in nominal and magnified views, an example rendering of a visual depiction displaying an authorization for and photographic representation of a person associated with the identification information obtained from an access seeker.

### DETAILED DESCRIPTION OF EMBODIMENTS

The repetitive nature of checking identification results in a tendency of some security guards to become complacent and fail to compare between physical characteristics of a person seeking access to an access-controlled location and physical characteristics of an access-authorized person shown in an image appearing on an identification card or a display screen. To mitigate this tendency of inattentive security guard behavior, the present inventors recognized that physical characteristics of a person associated with identification information could be provided to a security guard to indicate visual authorization information so that the security guard would simultaneously see visual authorization information and physical characteristics. This simultaneous presentation reduces a likelihood of incidence of a lapse in proper discharge of a routine, repetitive security procedure performed by the security guard monitoring the access-controlled location.

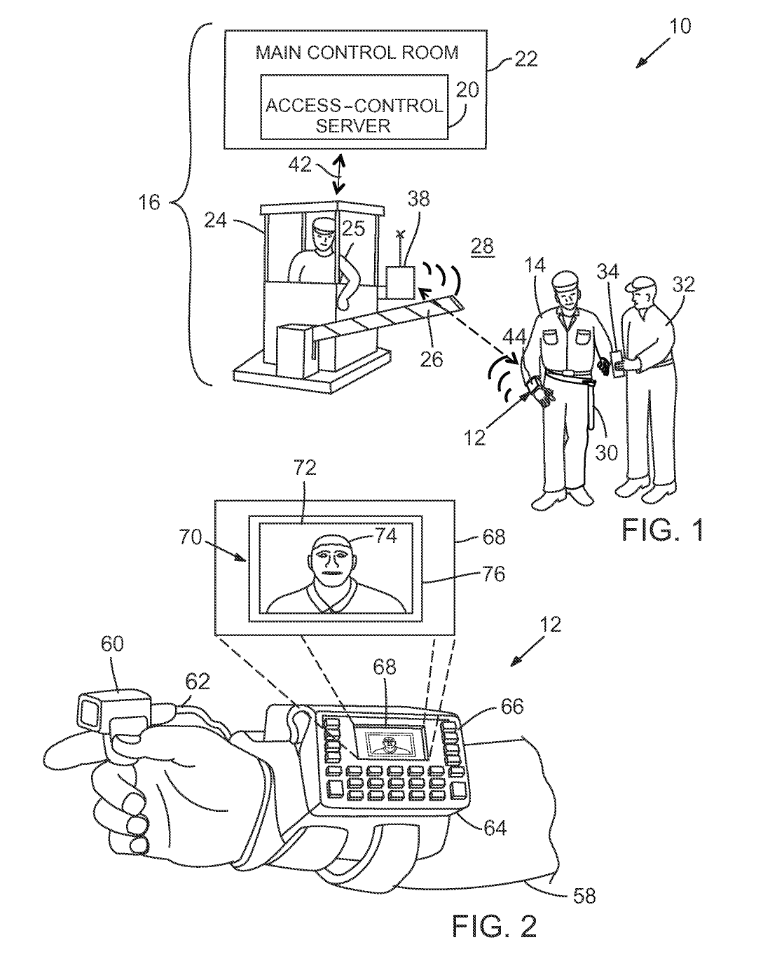

FIG. 1 is a block diagram showing a mobile identification-verification system 10 for reducing the likelihood of incidence of a lapse in proper discharge of the security procedure. System 10 includes an identification acquisition device 12 worn by a security guard 14, and an access-control system 16. According to one embodiment, access-control system 16 includes an access-control server 20 located inside a main control room 22, and an access controller 24 (e.g., gatehouse 24 with a gatekeeper 25 operating a gate 26) securing an access-controlled location 28.

Device 12 is configurable to be worn on either arm of security guard 14 so that a dominant hand (the left hand, for the case shown in FIG. 1) of security guard 14 is unencumbered for other use, such as making it available to deploy a weapon 30 in the event access seeker 32 poses a threat to security guard 14 or to authorized persons and facilities occupying location 28. Location 28 is accessible by access seeker 32 once security guard 14 uses device 12 to confirm that identification information appearing on identification card 34 (referred to simply as information 34) provided by access seeker 32 is associated with authorization and not misappropriated.

Gatehouse 24 provides an intermediary communications hub facilitating communications between device 12 and server 20. For example, gatehouse 24 includes both a wireless bridge 38 (such as a Viper 4200-LK, available from CDM Wireless of Youngsville, North Carolina), and a fiber LAN 42. Accordingly, some wireless communications from device 12 are received by gatehouse 24, and messages of those communications are provided to server 20 through fiber LAN interface 42. Specifically, FIG. 1 shows that information 34 is wirelessly transmitted by a transceiver 44 located in device 12 to wireless bridge 38 at gatehouse 24. Gatehouse 24, in turn, transmits (through fiber LAN 42) information 34 to main control room 22.

Main control room 22 includes stores of authorization data (e.g., a database) associated with persons authorized to access access-controlled location 28. In response to receiving information 34, server 20 of room 22 determines whether information 34 corresponds to stored authorization data associated with one of the authorized persons. For example, server 20 receives a name, unique alphanumeric access code, biometric data, or other identification information, and queries its database for an authorized person associated with that identification information.

Server 20, which may include web-based or cloud-based servers, then provides to device 12 authorization information indicative of whether information 34 corresponds to stored authorization data associated with one of the authorized persons. The authorization information may also include additional permissions or restrictions associated with the authorized person. For example, the authorized person may be permitted to enter location 28 by driving or riding in an inspected or uninspected vehicle. Device 12 receives the authorization information and presents visual authorization information so that security guard 12 can compare real-time observations of physical characteristics of access seeker 32 to physical characteristics provided by the visual authorization information. Additional details of the presentation of the visual authorization data are provided in subsequent paragraphs describing FIG. 2.

After access seeker 32 is validated, device 12 transmits to gatehouse 24, or directly to a gate control mechanism, a signal indicating that access seeker 32 is authorized to enter or occupy location 28.

FIG. 2 shows a portion of a right arm 58 of security guard 14 wearing device 12. Device 12 includes a finger-mounted data reader 60 (shown in the form of a ring fitted on the index finger of security guard 14) having a data cable 62 operatively coupling reader 60 to a user interface 64 of device 12. In another embodiment, an information acquisition device may be mounted on a belt or carried at other convenient locations.

Reader 60 includes an optical code reader in the form of a scan engine (SE), such as a model No. SE955, which is available from Motorola Solutions Inc. of Schaumburg, Ill. The scan engine is housed in a ring scanner (RS), such as a model No. RS409, which is also available from Motorola Solutions Inc. Reader 60 is finger-activated to read and decode barcode identification information presented by access seeker 32. In other embodiments, reader 60 includes a biometric reader, such as a fingerprint reader, to obtain biometric data identification information from access seeker 32. In still other embodiments, the biometric reader includes an imager used to acquire images of access seeker 32. The acquired images, or other biometric data, are used by server 20 to perform recognition between stored and acquired data. For example, server 20 performs facial recognition between an acquired image of an access seeker and stored images of authorized persons. A high correlation between acquired and stored biometric data indicates that the access seeker is the authorized person associated with the stored biometric data.

User interface 64 includes a keypad 66, a display screen 68, and a pair of cable-input ports (not shown) on opposing sides of interface 64. One of the ports nearest to reader 60 receives cable 62 when device 12 is carried on a left arm, and an opposite one of the ports receives cable 62 when device 12 is carried on a right arm. An example user interface 64 is a wearable terminal (WT) model No. WT4090, which is also available from Motorola Solutions, Inc.

Security guard 14 keystrokes user input to keypad 66. For example, security guard 14 using keypad 66 can revise authorization data, signal to gatehouse 24 whether access seeker 32 is an authorized person or a threat, modify device 12 configuration settings for receiving various forms of identification information, control security features such as security camera fields-of-view, or invoke alarms signifying a security breach. In some embodiments, device 12 receives functionally equivalent user input through any one or more of keypad 66 manipulation, voice-activated commands, or user gestures made to a touchscreen interface of display screen 68.

Display screen 68 presents for examination by security guard 14, in response to the authorization information received by transceiver 44, visual authorization information 70. Visual authorization information 70 may include visual indicators that are statically stored in user interface 64 memory and reproduced by device 12, provided by access-control system 16 for dynamically rendering on display screen 68, or some combination of locally stored and transmitted visual features. Device 12 also presents additional menus on display 68 to list those who have checked-in and those that have not checked-in.

According to one embodiment, in the event information 34 does not correspond to stored authorization data, a conspicuous red “X” appears on display screen 68. Alternatively, in the event information 34 does correspond to stored authorization data, an image 72 of one of the authorized persons 74 appears so that security guard 14 can readily compare physical characteristics of access seeker 32 to physical characteristics of person 74 shown in image 72 appearing on display screen 68.

In some embodiments, image 72 appears in the event information 34 is associated with authorization to access location 28, but does not appear in the event information 34 is for a non-authorized person. In other embodiments, image 72 appears when information 34 is associated with one of the authorized persons 74, and a conspicuous symbol 76 in the form of a border encompassing image 72 also appears to indicate whether person 74 is authorized or non-authorized. For example, the border is red in color whenever person 74 is non-authorized, and it is green in color whenever person 74 is authorized.

Some identification verification systems store a database of authorized persons directly on an access controller located at or near an entry point to an access-controlled location. Large-scale systems may use a server for managing decentralized authorization data stored in such access-controller databases. For example, Picture Perfect™, available from UTC Climate, Controls & Security (doing business as Lenel) of Bradenton, Fla., is a security management platform that allows users to enter instructions and personnel data into a server so that the server can download those instructions and data to door controllers in the system. In the event of server downtime, the door controllers possess locally stored authorization data available to verify identification information transmitted from an information acquisition device transmitter. Skilled persons will, therefore, understand that some access-control systems need not include a server, and, in some other embodiments, an information acquisition device may itself include authorization information.

Device 12 is typically carried by security guard 14 at a location that is remote from gatehouse 24 to provide separation between potential threats and an entry point of location 28. In some embodiments, however, device 12 may be carried at an access controller (such as by gatekeeper 25, FIG. 1) or carried within an access-controlled location. For example, device 12 may be carried inside location 28 to perform spot checks of identification information acquired from those inside location 28, generate muster reports listing persons known to be inside location 28, or to acquire information at an emergency staging or assembly area for a roll call in the event of an emergency. While validating and accounting for people located at an assembly area, device 12 logs persons who are checked in at the assembly area, and persons who are unaccounted for.

To call attention to a person of interest, device 12 provides two-way audio and video surveillance support including the ability to speak with gatekeeper 25 or other parties. In the event device 12 does not participate in pre-scheduled automated communication with server 20 or wireless bridge 38, server 20 or gatehouse 24 may initiate an alarm. Additionally, to assist in the initial installment or ongoing maintenance of system 10, device 12 records wireless signal integrity and monitors its wireless communication link. This information is then used improve the wireless coverage region or to train security guards to not attempt to use device 12 beyond its signal coverage region.

It will be understood by skilled persons that many changes may be made to the details of the above-described embodiments without departing from the underlying principles of the invention. The scope of the present invention should, therefore, be determined only by the following claims.

1. A method of reducing a likelihood of incidence of a lapse in proper discharge of a routine, repetitive security procedure performed by a security guard monitoring an access-controlled location, the security procedure including comparison by the security guard between physical characteristics of a person seeking access to the access-controlled location and physical characteristics of an access-authorized person shown in an image, the method comprising:
obtaining, with a hand-mounted identification acquisition device worn by the security guard, identification information from the person seeking access;
transmitting, from a transceiver operatively associated with the identification acquisition device to an access-control system, the identification information to cause the access-control system to cooperate with stores of authorization data associated with persons authorized to access the access-controlled location;
receiving with the transceiver, in response to the transmission of the identification information, a transmission from the access-control system of authorization information indicative of whether the identification information corresponds to stored authorization data associated with one of the authorized persons; and
presenting on a display screen for examination by the security guard, in response to the authorization information received by the transceiver, visual authorization information including first and second authorization indications, the first authorization indication appearing whenever the identification information does not correspond to the stored authorization data, and the second authorization indication appearing whenever the identification information corresponds to the stored authorization data, the second authorization indication including an image of the one of the authorized persons so that the security guard can compare the physical characteristics of the person seeking access to physical characteristics of the one of the authorized persons shown in the image appearing on the display screen.

2. The method of claim 1, in which the second authorization indication includes a conspicuous symbol presented contemporaneously with the image on the display screen to indicate that the identification information corresponds to the stored authorization data.

3. The method of claim 2, in which the conspicuous symbol comprises a colored border encompassing the image.

4. The method of claim 3, in which the colored border is green in color.

5. The method of claim 1, in which the stores of authorization data are further associated with persons non-authorized to access the access-controlled location, in which the authorization information is indicative of whether the identification information corresponds to first stored authorization data associated with the one of the authorized persons or corresponds to second stored authorization data associated with one of the non-authorized persons, and in which the second authorization indication appears whenever the identification information corresponds to the first or second stored authorization data.

6. The method of claim 5, in which the second authorization indication includes an image of the one of the non-authorized persons, and in which the second authorization indication includes a red border encompassing the image appearing on the display screen indicating the identification information corresponds to the second stored authorization data.

7. The method of claim 1, in which the first authorization indication includes a conspicuous symbol indicating the identification information does not correspond to the stored authorization data.

8. The method of claim 7, in which the conspicuous symbol is red in color.

9. The method of claim 1, in which the identification acquisition device includes a data reader having a ring that is sized to receive an index finger of the security guard.

10. The method of claim 9, in which the data reader is configured to be worn on a non-dominant hand of the security guard so that a dominant hand of the security guard unencumbered for other use.

11. The method of claim 1, further comprising transmitting, to a security facility, a signal indicating the person seeking access is authorized to enter or remain in the access-controlled location.

12. The method of claim 11, in which the security facility is a gatehouse, guardhouse, or entryway of the access-controlled location.

13. The method of claim 1, further comprising transmitting to a gatehouse, guardhouse, or entryway of the access-controlled location, an alarm signal indicating the person seeking access is not authorized to enter or remain in the access-controlled location.

14. The method of claim 1, in which the identification acquisition device is operatively associated with a wrist-mounted user interface, and further comprising:
receiving user input from the security guard manipulating the wrist-mounted user interface operatively associated with the identification acquisition device; and
transmitting a request to the access-control system to cause the access-control system to update the stored authorization data based on the user input.

15. The method of claim 14, in which the request indicates the one of the authorized persons should be not authorized to access the access-controlled location.

16. The method of claim 1, in which the identification acquisition device includes a biometric data reader, and in which the stores of authorization data include stored biometric data of persons authorized to access the access-controlled location, and further comprising:
acquiring, with the biometric data reader, acquired biometric data of the person seeking access to produce the identification information from the acquired biometric data; and
transmitting the acquired biometric data to the access-control system to cause the access-control system to perform biometric recognition between the acquired biometric data and the stored biometric data so as to determine whether the person seeking access corresponds to the one of the authorized persons.

17. The method of claim 16, in which the biometric data reader includes a camera, and in which the stored biometric data of persons authorized to access the access-controlled location include stored images of persons authorized to access the access-controlled location, and further comprising:
acquiring, with the camera, an acquired image of the person seeking access to produce the acquired biometric data; and
transmitting the acquired image to the access-control system to cause the access-control system to perform facial recognition between the acquired image and the stored images so as to determine whether the person seeking access corresponds to the one of the authorized persons.

18. The method of claim 1, in which the second authorization indication includes text-based authorization information specifying a criterion under which the one of the authorized persons is authorized to access the access-controlled location.

19. The method of claim 18, in which the criterion includes authorization to access by vehicle or by foot.

20. The method of claim 1, in which the second authorization indication includes text-based authorization information providing instruction for the security guard to inspect a vehicle or other object controlled by the one of the authorized persons.

21. Apparatus for reducing a likelihood of incidence of a lapse in proper discharge of a routine, repetitive security procedure performed by a security guard monitoring an access-controlled location, the security procedure including comparison by the security guard between physical characteristics of a person seeking access to the access-controlled location and physical characteristics of an access-authorized person shown in an image, the apparatus comprising:
a hand-mounted identification acquisition device worn by the security guard to obtain identification information from the person seeking access;
a transmitter operatively associated with the identification acquisition device and configured to transmit the identification information to an access-control system, the transmission causing the access-control system to cooperate with stores of authorization data associated with persons authorized to access the access-controlled location;
a receiver configured to receive, in response to the transmission of the identification information, a transmission from the access-control system of authorization information indicative of whether the identification information corresponds to stored authorization data associated with one of the authorized persons; and
a display screen to present for examination by the security guard, in response to the authorization information received by the transceiver, visual authorization information including first and second authorization indications, the first authorization indication appearing whenever the identification information does not correspond to the stored authorization data, and the second authorization indication appearing whenever the identification information corresponds to the stored authorization data, the second authorization indication including an image of the one of the authorized persons so that the security guard can compare the physical characteristics of the person seeking access to physical characteristics of the one of the authorized persons shown in the image appearing on the display screen.

22. The apparatus of claim 21, further comprising:
a data cable coupled to the identification acquisition device and terminating in a connector; and
a wrist-mounted user interface including the display screen and first and second input ports on opposing sides of the user interface, the first input port being disposed to receive the connector when the apparatus is worn on the security guard's right hand and wrist, and the second input port being disposed to receive the connector when the apparatus is worn on the security guard's left hand and wrist.

23. The apparatus of claim 21, further comprising a biometric data reader built in the identification acquisition device to obtain acquired biometric data of the person seeking access and produce the identification information, and in which the transmitter is configured to transmit the acquired biometric data to the access-control system to cause the access-control system to perform biometric recognition between the acquired biometric data and stored biometric data of authorized persons so as to determine whether the person seeking access corresponds to the one of the authorized persons.

24. The apparatus of claim 23, in which the acquired biometric data comprises an acquired image of the person seeking access, in which the biometric data reader comprises a camera built in the identification acquisition device to obtain the acquired image and produce the acquired biometric data, in which the transmitter is configured to transmit the acquired image to the access-control system to cause the access-control system to perform facial recognition between the acquired image and stored images of authorized persons so as to determine whether the person seeking access corresponds to the one of the authorized persons.

25. The apparatus of claim 21, further comprising a wrist-mounted user interface operatively associated with the identification acquisition device and including the display screen, and in which the user interface is configured to receive user input from the security guard for validating that the person seeking access matches the image appearing on the display screen.
